(19) United States
(12) Patent Application Publication
(10) Pub. No.: US 2026/0217012 A1
(43) Pub. Date: Jul. 30, 2026

(54) Smart Susceptor Induction Roller

(71) Applicant: NORTHROP GRUMMAN SYSTEMS CORPORATION, FALLS CHURCH, VA (US)

(72) Inventors: Matthew Toth, Falls Church, VA (US); Michael T. Tueller, Falls Church, VA (US); Nathan Nyman, Falls Church, VA (US); Vernon M. Benson, Falls Church, VA (US)

(21) Appl. No.: 19/041,405

(22) Filed: Jan. 30, 2025

(51) Int. Cl. B32B 37/06; B32B 37/00; B32B 37/10

(52) U.S. Cl. CPC B32B 37/06; B32B 37/0053; B32B 37/10

(57) ABSTRACT

A roller assembly including a support structure, a roller rotatably coupled to the support structure and having a core with a central bore, where the core is made of a smart susceptor alloy that is designed to be heated to and held at a predetermined temperature range, and an induction coil positioned within the central bore and being stationarily fixed to the support structure, where the induction coil provides the energy that heats the core. In some embodiments, the roller has an outer elastomer layer that can be a silicone layer and/or is doped with a material that makes the layer more inductive and/or is doped with a material that makes the layer more conducive to heating.

### BACKGROUND

### Field

This disclosure relates generally to a roller assembly for heating and compacting material layers together as they are being laminated and, more particularly, to a roller assembly for heating and compacting material layers together as they are being laminated, where the roller assembly includes a rotatable roller having a core and a fixed induction coil positioned within the core, and where the core is made of a smart susceptor alloy that is designed to be heated to and held at a predetermined temperature range and the induction coil provides the energy that heats the core.

### Discussion of the Related Art

Composite structures are generally fabricated by laminating multiple plies of composite materials together in specific shapes, and then curing the laminate with heat and pressure to obtain a solid laminate structure. If the plies are not compacted well enough during lamination, the final structure that is cured in an oven or autoclave or press or other cure/consolidation process can result in wrinkles/waves in the fibers of the resulting composite structure. These wrinkles/waves result in decreased performance in the structure and can cause the parts to be scrapped completely.

Stiffeners are structural members that are attached to larger structural panels or to a framework of structural members to stiffen them against out-of-plane deformations and carry needed loads throughout an assembly or structure. Because of strength and weight requirements, composite stiffeners are often used in aircraft structures to, for example, provide skin panels with some resistance to bending and buckling loads. Manufacturing composite stiffeners typically requires the machining of a mold or tool having the same general shape as the stiffener. The tool can then be positioned under an automated lamination machine. A resin pre-impregnated fiber material format (prepreg) of the composite material is then generally laid on top of the mold and a working head is moved along the composite material to heat, form and compact the composite prepreg to the tool or layers already applied to the tool.

The current state of the art employs a heater, such as an infrared heater, a hot gas heater, a laser heater, an induction heater, etc., and a roller work head to form and compact the composite material. For the induction heater, an induction coil is generally mounted in front of the roller so that the material can be heated through induction and then be compacted by the roller. The molded composite stiffener then may be cured in an oven or autoclave or some other suitable curing device.

The development of next generation light weight, high performance stiffeners that employ other types of composite materials, such as dry fiber and thermoplastic materials, will require more advanced methods of heating and compacting of the materials. For example, known work head designs, such as those employing infrared heating, cannot be used to effectively heat through thick multi-ply material formats being applied, and induction heat does not interact well with multiple unidirectional materials stacked in the same orientation or with nonconductive composite materials. This provides a number of disadvantages including: decreased compaction quality because of the delay between heating and compacting the material; the inability to work with thermoplastics for automated forming because of the insulating nature of thermoplastic resin within the composite fiber material; difficulties heating multiple stacks of unidirectional plies with induction; and the manufacturing rate impacts due to inconsistencies in heating stemming from induction coil design and material irregularities.

### SUMMARY

The following discussion discloses and describes a roller assembly that has application as part of a manufacturing system that heats and compacts materials. The roller assembly includes a support structure, a roller rotatably coupled to the support structure and having a core with a central bore, where the core is made of a smart susceptor alloy that is designed to be heated to and held at a predetermined temperature range, and an induction coil positioned within the central bore and being stationarily fixed to the support structure, where the induction coil provides the energy that heats the core. In some embodiments, the roller has an outer elastomer layer that can be a silicone layer and/or is doped with a material that makes the layer more inductive and/or is doped with a material that makes the layer more inducive to heating.

Additional features of the disclosure will become apparent from the following description and appended claims, taken in conjunction with the accompanying drawings.

### BRIEF DESCRIPTION OF THE DRAWINGS

FIG. 1 is an isometric view of a manufacturing system for heating and compacting composites and including a smart susceptor induction roller assembly;

FIG. 2 is a side view of the system shown in FIG. 1;

FIG. 3 is a front cross-sectional type view of the system shown in FIG. 1;

FIG. 4 is a cross-sectional isometric view of the smart susceptor induction roller assembly; and

FIG. 5 is an isometric view of the smart susceptor induction roller assembly with the roller removed.

### DETAILED DESCRIPTION OF THE EMBODIMENTS

The following discussion of the embodiments of the disclosure directed to a roller assembly for heating and compacting material layers together as they are being laminated, where the roller assembly includes a rotatable roller having a core and a fixed induction coil positioned within the core, and where the core is made of a smart susceptor alloy that is designed to be heated to and held at a predetermined temperature range and the induction coil provides the energy that heats the core, is merely exemplary in nature, and is in no way intended to limit the disclosure or its applications or uses.

As will be described in detail below, this disclosure proposes a smart susceptor heated roller that employs a stationary internal induction coil. The induction coil heats the smart susceptor roller to its curie temperature where the roller then holds to a pre-determined temperature range regardless of the induction field, and then is used to heat and compact material layers together. The example of heating and compacting dry carbon fiber preforms is one practical example of the usefulness of the design. The roller can also include a thin external layer of a high temperature elastomer material to increase the contact area and even out the pressure over surfaces that are not perfectly smooth. The roller rapidly and efficiently heats up to the maximum temperature of the susceptor material. In addition, the induction field almost instantly reheats the roller as heat is transferred into the material being compacted. The heated roller allows for precise heating of a variety of materials including dry carbon fiber formats and thermoplastic prepregs. By combining the heater and roller the form factor of a composite forming station can be cut in half and the overall efficiency of the manufacturing system can be improved. By removing the delay between heating and compaction, improved manufacturing quality as well as an increase in manufacturing speed are possible. By induction heating the roller it is possible to remove some of the inconsistencies associated with directly heating carbon fiber material formats. Also, the heated roller allows for new nonconductive materials to be formed, such as fiberglass fiber type composites and laminates where there is a high percentage of unidirectional carbon fiber plies together in the composite design.

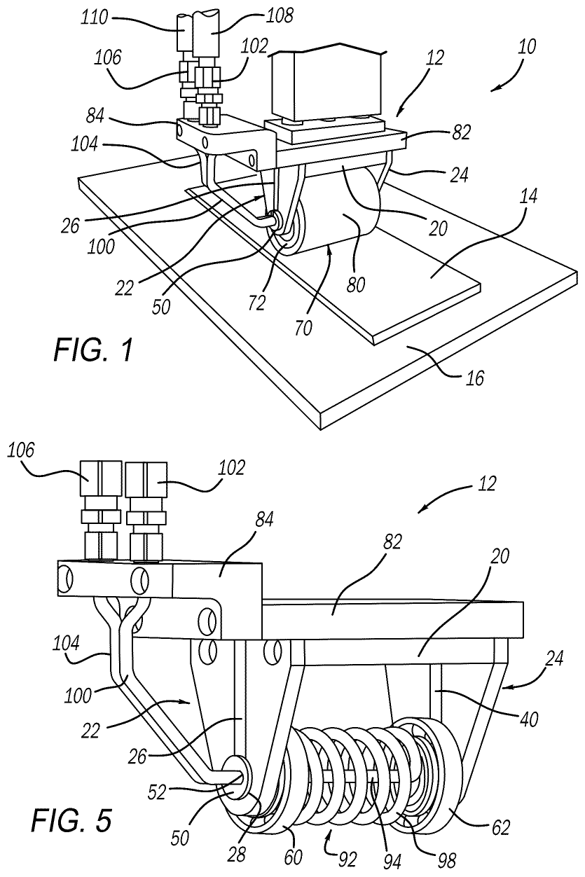

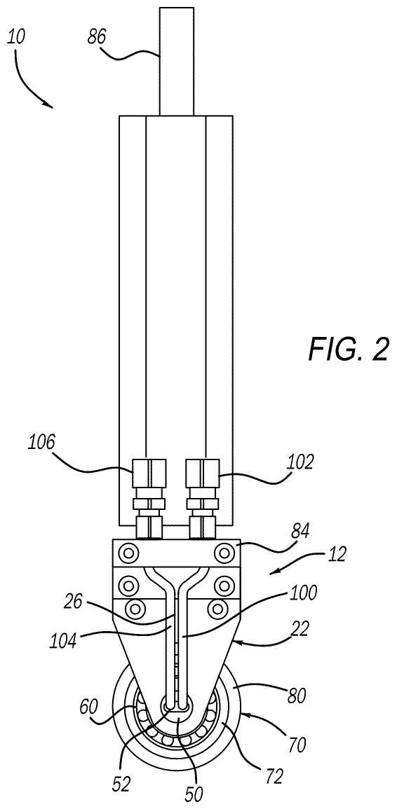

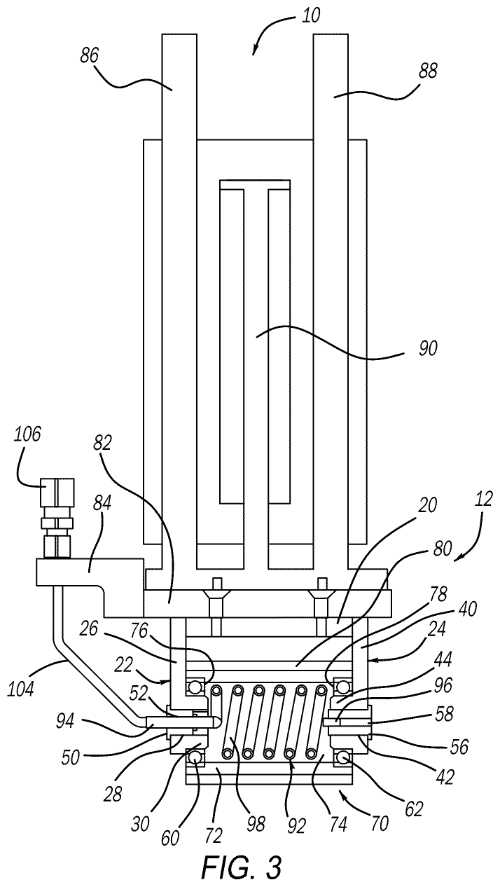

FIG. 1 is an isometric view of a manufacturing system 10 for heating and compacting composites that includes a smart susceptor induction roller assembly 12 and a preform 14 of a composite material that is laid on top of a mold or platform 16. In one non-limiting embodiment, the system 10 manufactures composite stiffeners with carbon fiber materials. However, the induction roller assembly 12 is applicable for manufacturing other structures and other materials, such as plastic film to paper, pre-preg manufacturing, thermoplastic welding, etc. FIG. 2 is a side view and FIG. 3 is front cross-sectional type view of the system 10 where the preform 14 and the platform 16 have been removed. The roller assembly 12 includes a base plate 20 and opposing end support arms 22 and 24 that are bolted to the ends of the plate 20. The support arm 22 includes a slot 26, an opening 28 at the bottom of the slot 26 and an internal collar 30 formed around the opening 28. Likewise, the support arm 24 includes a slot 40, an opening 42 at the bottom of the slot 40 and an internal collar 44 formed around the opening 42. A flexible insulative plug 50 is inserted into the opening 28 and the collar 30 and includes a central opening 52, and a flexible insulative plug 56 is inserted into the opening 42 and the collar 44 and includes a central opening 58. A ring bearing 60 is fixed to the collar 30 and a ring bearing 62 is fixed to the collar 44. In one non-limiting embodiment, the bearings 60 and 62 are commercial off-the-shelf (COTS) cubic zirconia bearings. Cubic zirconia is a ceramic material transparent to induction fields, which prevents the bearings 60 and 62 from heating in an induction field as typical aluminum or steel bearings would. Additionally, in one embodiment, the ceramic bearings 60 and 62 are rated for temperatures exceeding 1000° F., which ensures that they do not seize as a result of heat transfer.

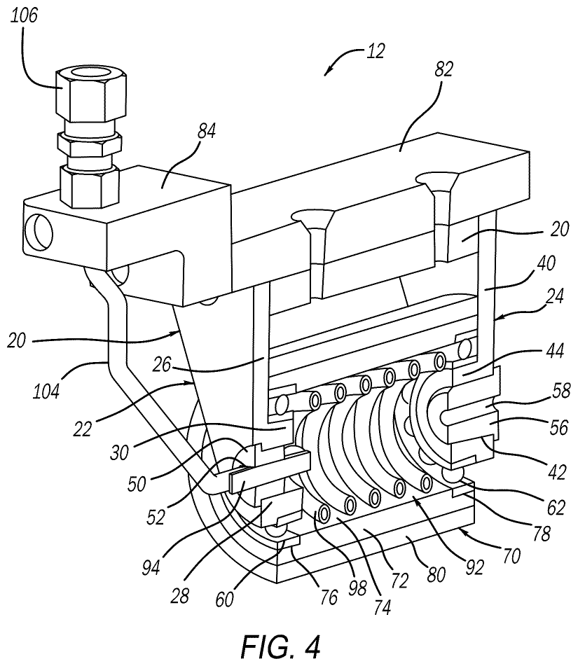

FIG. 4 is a cross-sectional isometric view of the smart susceptor induction roller assembly 12. The roller assembly 12 further includes a roller 70 having a metal core 72 with a central bore 74 and annular end slots 76 and 78 and an optional outer elastomer layer or casing 80. In one non-limiting embodiment, the casing 80 is silicone and is about 5 mm thick. Further, the casing 80 can be doped with a material that makes the casing 80 more inductive and/or doped with a material that makes the casing 80 more conducive to heating, where the doping material may be a smart susceptor alloy material. FIG. 5 is an isometric view of the roller assembly 12 with the roller 70 removed. The metal core 72 is made of a smart susceptor alloy, which is a ferromagnetic material that has a Curie point at or just above the processing temperature of the material being formed. More particularly, by balancing the thickness and metallic composition of the core 72, the susceptor alloy is intrinsically designed to have a specific Curie temperature, which effectively limits the maximum temperature of the core 72 to the desired processing temperature of the material being compacted, such as composite materials. Smart susceptor alloys are able to be formulated with varying Curie temperatures, which enables the designer to set the maximum inductive temperature of the roller 70, thus ensuring that the roller 70 doesn't overheat the material being compacted. Suitable susceptor alloys could include Kovar, Moly-Permalloy and Invar. The casing 80 provides a larger, more consistent compaction contact footprint, effectively transfers heat from the core 72 and distributes force evenly (unlike metallic rollers, which tend to apply inconsistent pressure depending on the local thickness deviation of the surface being compacted). The slot 76 is positioned on the bearing 60 and the slot 78 is positioned on the bearing 62, which allows the roller 70 to rotate independent of the rest of the roller assembly 12. The base plate 20 is bolted to a support platform 82 and an L-shaped bracket 84 is bolted to the platform 82. A pair of guide rods 86 and 88 are secured to the platform 82 and a piston rod 90 is provided between the rods 84 and 86 and is actuated to apply pressure to the roller 70.

A hollow induction coil 92 is positioned within the bore 74 and includes a straight central portion 94 extending through the opening 52 in the plug 50 and a projection 96 inserted into the opening 58 in the plug 56, which maintains the coil 92 centrally located in the bore 74 and prevents it from contacting the metal core 72. The induction coil 92 also includes a helical portion 98 that is wound around the straight portion 94 and extends through the opening 52 in the plug 50. The induction coil 92 also includes a connection portion 100 connecting the straight portion 94 to a fixture 102 mounted to the bracket 84 and a connection portion 104 connecting the helical portion 98 to a fixture 106 mounted to the bracket 84. The slots 26 and 40 facilitate the ability of the coil 92 to be positioned within the core 72. In one embodiment, a water supply line 108 is connected to the fixture 102 and a water return line 110 is connected to the fixture 106 so as to allow cooling water, or other coolant, to flow through the induction coil 92. An induction unit (not shown) would also be coupled to the lines 108 and 110 to provide the power, energy and cooling for the coil 92 to induct.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A roller assembly comprising:
a support structure;
a roller rotatably coupled to the support structure and including a core having a central bore, said core being made of a smart susceptor alloy that is designed to be heated to and held at a predetermined temperature range; and
an induction coil positioned within the central bore and being stationarily fixed to the support structure, said induction coil providing the energy that heats the roller.

2. The roller assembly according to claim 1 wherein the induction coil includes a straight portion and a helical portion wound around the straight portion.

3. The roller assembly according to claim 2 wherein the straight portion includes a feature that interfaces with the support structure to maintain the induction coil centered in the bore.

4. The roller assembly according to claim 1 wherein the roller includes an outer elastomer layer formed around the core.

5. The roller assembly according to claim 4 wherein the elastomer layer is a silicone layer.

6. The roller assembly according to claim 4 wherein the elastomer layer is doped with a material that makes the layer more inductive.

7. The roller assembly according to claim 4 wherein the elastomer layer is doped with a material that makes the layer more conducive to heating.

8. The roller assembly according to claim 1 wherein the smart susceptor alloy is Kovar, Moly-Permalloy or Invar.

9. The roller assembly according to claim 1 wherein the roller is rotatable on cubic zirconia bearings mounted to the support structure.

10. The roller assembly according to claim 1 wherein the induction coil is hollow so as to accept a cooling fluid.

11. The roller assembly according to claim 1 wherein the roller assembly is part of a manufacturing system that makes composite stiffeners.

12. A roller assembly comprising:
a support structure;
a roller rotatable coupled to the support structure, said roller including a core having a central bore; and
an induction coil positioned within the central bore and being stationarily fixed to the support structure, said induction coil providing energy to heat the roller.

13. The roller assembly according to claim 12 wherein the induction coil includes a straight portion and a helical portion wound around the straight portion.

14. The roller assembly according to claim 13 wherein the straight portion includes a feature that interfaces with the support structure to maintain the induction coil centered in the bore.

15. The roller assembly according to claim 12 wherein the roller includes an outer elastomer layer formed around the core.

16. The roller assembly according to claim 15 wherein the elastomer layer is a silicone layer and/or is doped with a material that makes the layer more inductive and/or is doped with a material that makes the layer more conducive to heating.

17. A manufacturing system that makes a laminate structure, said manufacturing system including a roller assembly that applies heat and pressure to the laminate structure as it is being laminated and formed, said roller assembly comprising:
a support structure including a base plate and opposing support arms extending therefrom, each support arm having an opening and an annular collar formed around the opening and facing the other support arm;
a bearing mounted to each of the collars;
a roller including a core having an annular slot at each end of the core and a central bore therebetween, said core being made of a smart susceptor alloy that is designed to be heated to and held at a predetermined temperature range, said roller being positioned so that one of the bearings is positioned within each annular slot and the roller is rotatable on the bearings; and
an induction coil positioned within the central bore and being stationarily fixed to the support arms, said induction coil providing the energy that heats the core.

18. The system according to claim 17 wherein the roller includes an outer elastomer layer formed around the core.

19. The system according to claim 18 wherein the elastomer layer is a silicone layer and/or is doped with a material that makes the layer more inductive and/or is doped with a material that makes the layer more conducive to heating.

20. The system according to claim 17 wherein the support arms are split arms having a slot that is in communication with the opening.
